(19) United States
(12) Patent Application Publication
(10) Pub. No.: US 2011/0273424 A1
(43) Pub. Date: Nov. 10, 2011

(54) DISPLAY PANEL DATA DRIVER AND DISPLAY APPARATUS INCLUDING SAME

(75) Inventors: Joo-won HWANG, Suwon-si (KR); Chang-sig KANG, Hwaseong-si (KR)

(73) Assignee: SAMSUNG ELECTRONICS CO., LTD., Suwon-si (KR)

(21) Appl. No.: 13/100,583

(22) Filed: May 4, 2011

(30) Foreign Application Priority Data
May 10, 2010 (KR) 10-2010-0043605

(51) Int. Cl. G06F 3/038

(52) U.S. Cl. 345/211

(57) ABSTRACT

A data driver driving a display panel includes a data processing unit receiving digital data synchronously with a master clock signal and storing the digital signal, and a driving signal output unit generating a driving signal corresponding to the digital data in response to a driving instruction signal, and outputting the driving signal to the display panel. The data processing unit is activated at an activation time determined according to a setting signal.

### CROSS-REFERENCE TO RELATED APPLICATIONS

This application claims the benefit of Korean Patent Application No. 10-2010-0043605 filed on May 10, 2010, the subject matter of which is hereby incorporated by reference.

### BACKGROUND OF THE INVENTION

The inventive concept relates to data drivers configured to drive corresponding display panel(s), as well as display apparatuses including such data drivers. More particularly, the inventive concept relates to data drivers that automatically activate at a previously designated time and receive digital data even if an activation signal is not externally applied to the data driver and display apparatuses including such data drivers.

Portable electronic devices, such as notebook computers, Personal Digital Assistants (PDAs), and personal portable communication devices, are widely used by consumers along with digital home electronic appliances and Personal Computers (PCs). Such devices typically incorporate a display apparatus. Contemporary display devices are increasingly light weight and provide high resolution images while consuming relatively low levels of power. Flat panel displays (FPDs) are commonly used in contemporary electronic devices as replacements for cathode ray tubes (CRTs) and include, as examples, liquid crystal displays (LCDs), plasma display panels (PDPs), and organic electro-luminance displays (OLEDs). However, display apparatuses incorporating large-size and high resolution FPDs require relatively large quantities of data per transmitted image frame. Accordingly, emerging display apparatuses must stably transmit great volumes of data at relatively high speed.

### SUMMARY OF THE INVENTION

Embodiments of the inventive concept provide a data driver that is automatically activated at a previously designated time and receives digital data even if an activation signal is not externally applied to the data driver. Such embodiments also provide a display apparatus including a data driver that is automatically activated at a previously designated time and receives digital data even if an activation signal is not externally applied to the data driver.

According to an aspect of the inventive concept, there is provided a display apparatus comprising; a display panel, a timing controller that provides a master clock signal and digital data, and a data line driving unit comprising a plurality of data drivers, each configured to receive the master clock signal, receive and store the digital data, generate driving signals in accordance with the stored digital data, and provide corresponding driving signals to the display panel, wherein the plurality of data drivers is sequentially activated to receive and store the digital data in response a corresponding one of a plurality of setting signals.

According to another aspect of the inventive concept, there is provided a display apparatus comprising; a display panel, a timing controller that provides a master clock signal, digital data, and a driving instruction signal, and a data line driving unit comprising a plurality of data drivers, each configured to receive the master clock signal, receive and store the digital data, generate driving signals in accordance with the stored digital data, and provide corresponding driving signals to the display panel, wherein the plurality of data drivers is sequentially activated to receive and store the digital data in response to a corresponding one of a plurality of setting signals, and each of the plurality of data drivers comprise; a data processing unit that receives the digital data synchronously with the master clock signal and stores the received digital data, and a driving signal output unit that generates the driving signals in response to the stored digital data and the driving instruction signal, and provides the driving signals to the display panel.

According to another aspect of the inventive concept, there is provided a data driver driving a display panel, the data driver comprising; a data processing unit that receives digital data synchronously with a master clock signal and stores the received digital data; and a driving signal output unit that generates driving signals in response to the stored digital data and a driving instruction signal, and provides the driving signals to a display panel, wherein the data processing unit is activated at a time determined by an applied setting signal.

### BRIEF DESCRIPTION OF THE DRAWINGS

Certain embodiments of the inventive concept will be more clearly understood from the following detailed description taken in conjunction with the accompanying drawings in which:

FIG. 1 is a block diagram of a display apparatus according to an embodiment of the inventive concept;

FIG. 2 is a block diagram further illustrating one possible data line driving unit including three data drivers that may be incorporated within the embodiment of FIG. 1;

FIG. 3 is a block diagram of a display apparatus according to another embodiment of the inventive concept;

FIG. 4 is a block diagram further illustrating one possible data line driving unit including three data drivers that may be incorporated within the embodiment of FIG. 3, wherein one-bit setting signals are respectively applied to the data drivers;

FIG. 5 is a block diagram of the data line driving unit of FIG. 3, however including five data drivers to which two-bit setting signals are respectively applied;

FIGS. 6A and 6B are tables listing exemplary setting signals for the data drivers of the data line driving unit of FIG. 3;

FIG. 7 is a diagram further illustrating a mini-low-voltage differential signaling (LVDS) interface applied between a timing controller and a data driver that may be included in a display apparatus according to an embodiment of the inventive concept;

FIGS. 8 and 9 illustrate exemplary protocol(s) that may be used in conjunction with the mini-LVDS interface of FIG. 7;

FIG. 10 is a data diagram illustrating data received by data drivers operating in conjunction with the mini-LVDS interface of FIG. 7;

FIG. 11 is a diagram illustrating n^{th} line data output from a timing controller and distributed across five data drivers included in a display apparatus according to an embodiment of the inventive concept;

FIG. 12 is a block diagram of a data driver according to an embodiment of the inventive concept;

FIG. 13 is a block diagram further illustrating the data processing unit of FIG. 12; and

FIG. 14 is a block diagram further illustrating the control unit of FIG. 13.

### DETAILED DESCRIPTION

The inventive concept will now be described in some additional detail with reference to the accompanying drawings in which certain exemplary embodiments of the inventive concept are shown. The inventive concept may, however, be embodied in many different forms and should not be construed as being limited to only the illustrated embodiments. Rather, the illustrated embodiments are provided so that this disclosure will be thorough and complete and will fully convey the concept of the inventive concept.

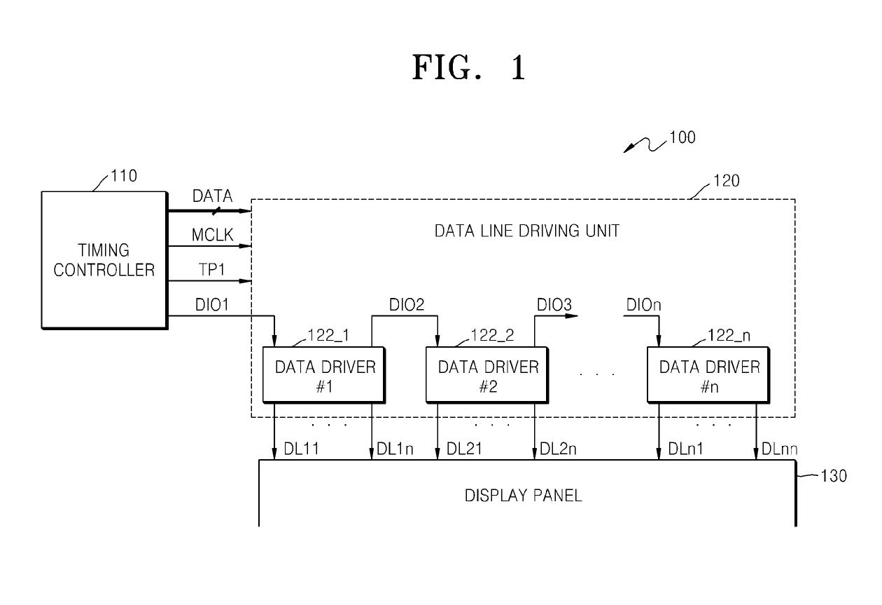

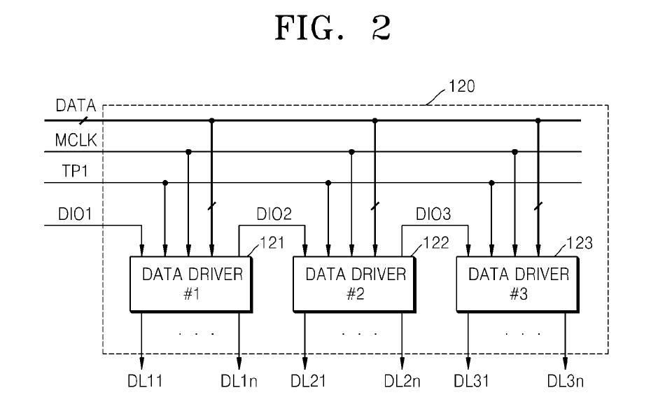

FIG. 1 is a block diagram of a display apparatus 100 according to an embodiment of the inventive concept. FIG. 2 is a block diagram further illustrating one possible data line driving unit including three data drivers that may be incorporated within the embodiment of FIG. 1.

Referring to FIGS. 1 and 2, the display apparatus 100 includes a timing controller 110, a data line driving unit 120, and a display panel 130. The timing controller 110 outputs a driving instruction signal (TP1), a master clock signal (MCLK) and digital data (DATA) to the data line driving unit 120. The data line driving unit 120 includes a plurality of data drivers 122_1 through 122_{—}n that apply driving signals to data lines DL11 through DLnn of the display panel 130. The data drivers 122_1 through 122_{—}n are sequentially activated in response to start pulses DIO1 through DIOn corresponding thereto, receive the digital data from the timing controller 110, and generate and output the start pulses DIO2 through DIOn used to activate next data drivers at appropriate times. More specifically, the first data driver 122_1 is activated in response to the start pulse DIO1, which is received from the timing controller 110, and the second through n^{th} data drivers 122_2 through 122_{—}n are cascade activated in response to start pulses DIO2 through DIOn which are received from the data drivers 122_1 through 122_{—}n−1, respectively. As described above, the display apparatus 100 includes the data drivers 122_1 through 122_{—}n that are respectively activated in response to the start pulses DIO1 through DIOn, wherein each one of the start pulses DIO1 through DIOn is externally and respectively applied to the data drivers 122_1 through 122_{—}n. Thus, configuration of display apparatus 100 requires connecting signal lines (i.e., wirings) for the start pulses DIO1 through DIOn. This requirement markedly increases the size of a printed circuit board (PCB) on which the display apparatus is fabricated and drives up cost of manufacture. Further, since each one of the data drivers 122_1 through 122_{—}n is “cascade activated” (i.e., sequentially activated in turn) by a corresponding one of the start pulses DIO1 through DIOn, the display apparatus 100 may malfunction due to signal distortion, interruption, or delay associated with a single one of the start pulses DIO1 through DIOn.

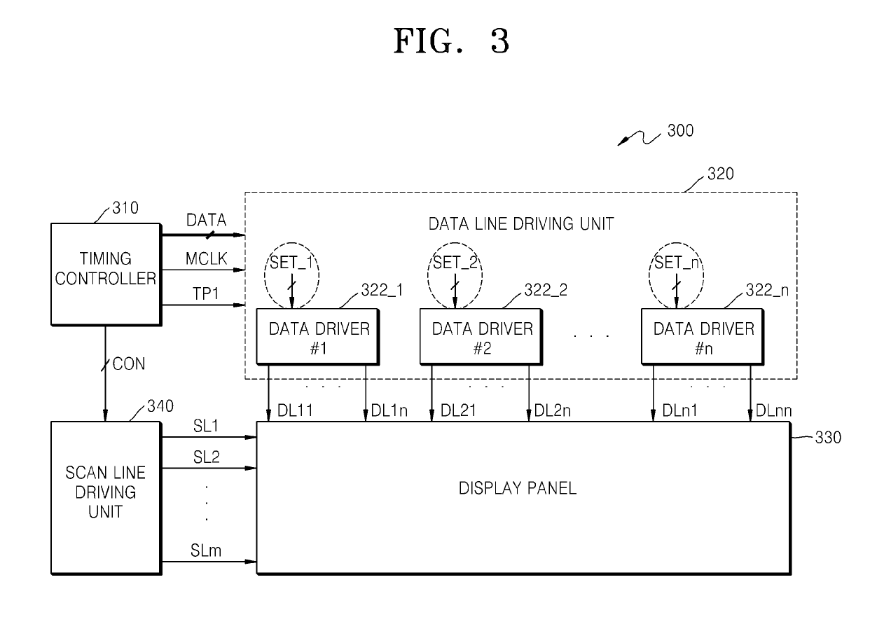

FIG. 3 is a block diagram of a display apparatus 300 according to another embodiment of the inventive concept. Referring to FIG. 3, the display apparatus 300 includes a timing controller 310, a data line driving unit 320, a scan line driving unit 340, and a display panel 330.

The display panel 330 is assumed to include a plurality of scan lines SL1 through SLm and a plurality of data lines DL11 through DLnn conventionally arranged to define respective unit pixels (not shown) at points where the scan lines SL1 through SLm and the data lines DL11 through DLnn intersect.

The timing controller 310 controls the overall operation of the data line driving unit 320 and the scan line driving unit 340. As part of this overall control process, the timing controller 310 provides a master clock signal (MLCK), digital data (DATA), and a driving instruction signal (TP1) to the data line driving unit 320.

The scan line driving unit 340 receives a control signal (CON), which may include one or more individual control signals but will be referred to hereafter singularly and collectively as the control signal (CON), from the timing controller 310 and sequentially activates scan lines SL1 through SLm of the display panel 330. The scan line driving unit 340 sequentially applies scan pulses (or gate-ON pulses) to the scan lines SL1 through SLm of the display panel 330. The unit pixels (not shown) respectively associated with the scan lines SL1 through SLm to which the scan pulses are applied also receive driving signals that are applied through the data lines DL11 through DLnn. The control signal (CON) may include, for example, one or more clock signal(s) generated by the timing controller 310, a vertical start signal controlling activation of the scan line driving unit 340, an output enable signal used to control the activation width for each of the scan lines SL1 through SLm, etc.

The data line driving unit 320 includes n (where “n” is a natural number greater than 1) data drivers 322_1 through 322_{—}n that apply corresponding driving signals to the data lines DL11 through DLnn of the display panel 330. The data drivers 322_1 through 322_{—}n receive the master clock signal, digital data, and driving instruction signal from the timing controller 310, generate the required driving signals, and then apply the driving signals to the data lines DL11 through DLnn. To drive the display apparatus 330, the data drivers 322_1 through 322_{—}n are sequentially activated to receive the digital data provided by the timing controller 310 and store same. When the data drivers 322_1 through 322_{—}n finish receiving the digital data, they generate the driving signals in accordance with the stored digital data in response to the driving instruction signal, and then apply the driving signals to the corresponding data lines DL11 through DLnn.

More specifically, each one of the data drivers 322_1 through 322_{—}n receives the master clock signal provided by the timing controller 310, and are respectively activated at designated times to receive the digital data also provided by the timing controller 310. However, the data drivers 322_1 through 322_{—}n according to the illustrated embodiment of the inventive concept are not activated in response to externally provide start pulses, unlike the data drivers 122_1 through 122_{—}n included in the display apparatus 100 shown in FIGS. 1 and 2. Instead, the data drivers 322_1 through 322_{—}n receive corresponding setting signals SET_1 through SET_{—}n. The setting signals SET_1 through SET_{—}n determine the respective time at which each one of the data drivers 322_1 through 322_{—}n is activated. Therefore, the setting signals SET_1 through SET_{—}n may be defined in such a way that the data drivers 322_1 through 322_{—}n corresponding thereto are properly, sequentially activated. The data drivers 322_1 through 322_{—}n may thus be activated at respective activation times according to the setting signals SET_1 through SET_{—}n corresponding thereto to receive the digital data provide by the timing controller 310.

The setting signals SET_1 through SET_{—}n respectively applied to the data drivers 322_1 through 322_{—}n may each be digital control signals of one or more bits. A minimum number of bits forming the setting signals SET_1 through SET_{—}n may be determined in accordance with the number, layout and/or activation time(s) for each of the data drivers 322_1 through 322_{—}n. The setting signals SET_1 through SET_{—}n may be applied to the data drivers 322_1 through 322_{—}n from the timing controller 310 using a conventionally understood multi-drop method for control signal connection. For example, if the number of the data drivers 322_1 through 322_{—}n connected to the timing controller 310 using the multi-drop method is 4 or more, the setting signals SET_1 through SET_{—}n applied to each of the data drivers 322_1 through 322_{—}n will include at least two (2) bits so as to properly identify the four or more data drivers 322_1 through 322_{—}n.

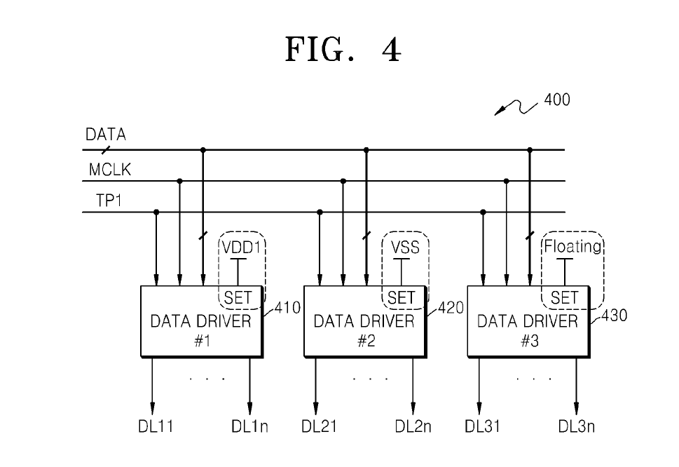

FIG. 4 is a block diagram of a data line driving unit 400, in relevant portion, that serves to further illustrate the data line driving unit 320 of FIG. 3, including as a more specific example, three (i.e., n=3) data drivers 410 through 430 each receiving respective one-bit setting signals. The three data drivers 410 through 430 each receive the master clock signal, digital data, and driving instruction signal from the timing controller 310. The three data drivers 410 through 430 include setting terminals (SET) used to receive respective setting signals. The particular voltage level (and/or corresponding digital bit value) for the setting signals applied to the respective setting terminals of the three data drivers 410 through 430 may be defined during the manufacture of the display apparatus 300. For example, in the illustrated embodiment of FIG. 4, the setting terminals of the three data drivers 410 through 430 are respectively connected to a power voltage VDD1, a ground voltage VSS, and floating voltage. Thus, the particular setting signals applied to the three data drivers 410 through 430 may be respectively interrupted (e.g., established by logical definition) as logical “high”, logical “low” and a high impedance Hi-Z. Thus, the three data drivers 410 through 430 may be distinguished from each other by application of different setting signals. More specifically, the first data driver 410 having its setting terminal SET connected to the power voltage VDD1 is first activated in response to the setting signal associated with a corresponding first activation time, receives and stores the digital data provided by the timing controller 310. After the first data driver 410 finishes the receipt and storing of the digital data, the second data driver 420 having its setting terminal SET connected to the ground voltage VSS is activated in response to the setting signal associated with a corresponding second activation time later than the first activation time, and receives and stores the digital data. Finally, after the second data driver 420 finishes the receipt and storing of the digital data, the third data driver 430 having its setting terminal SET connected to a floating voltage is activated in response to the setting signal associated with a corresponding third activation time later than the second activation time, and receives and stores the digital data. The three data drivers 410 through 430 are thus sequentially activated in response to different setting signals to receive the digital data provided by the timing controller 310. Once the three data drivers 410 through 430 finish receiving the digital data, they will respectively generate driving signals corresponding to the stored digital data in response to the driving instruction signal also provided by the timing controller 310. In this manner, the driving signals applied to the data lines DL11 through DL3n of the display panel 340 are generated.

Of course, the foregoing example is just one example of many different control signal applications that may be used to differentiate the respective activation times for the data drivers of a display apparatus. Of note, a power voltage, ground voltage, and floating voltage are readily available within the circuitry typically used to configure a data line driving unit. However, any reasonably provided and rationally defined collection of setting signals may be used within various embodiments of the inventive concept.

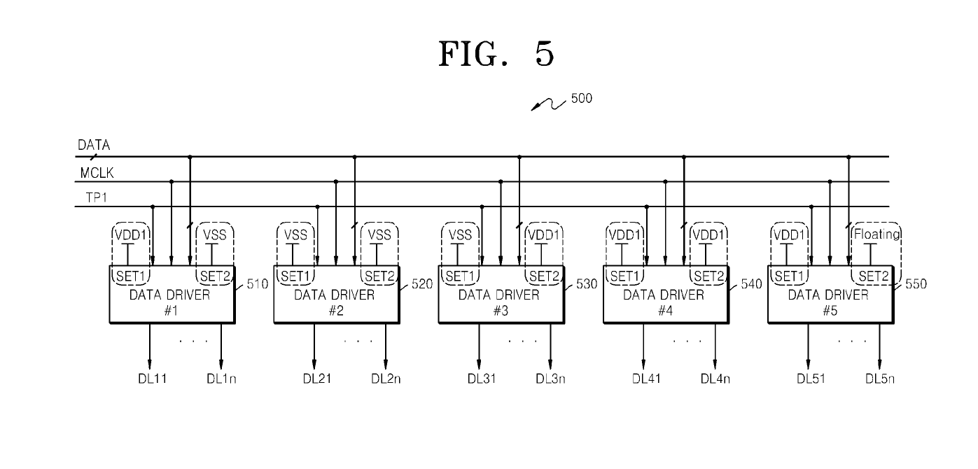

FIG. 5 is a block diagram further illustrating the data line driving unit 320 of FIG. 3 including five data drivers 510 through 550 to which two-bit setting signals are respectively applied. Referring to FIGS. 3 and 5, the display apparatus 300 is now assumed to include five data drivers 510 through 550 to drive the display panel 330. As before, the five data drivers 510 through 550 each receive the master clock signal, the digital data, and the driving instruction signal from the timing controller 310. However, the five data drivers 510 through 550 each include two setting terminals SET1 and SET2 used to receive a 2-bit setting signal. Here again, the particular setting signals and their control definition upon a respective one of the five data drivers 510 through 550 may be established during manufacture. In the illustrated embodiment of FIG. 5, the setting terminals SET1 and SET2 are variously connected to the power voltage VDD1 (high) or the ground voltage VSS (low), or the floating voltage (Hi-Z). Thus, the five data drivers 510 through 550 may be distinguished from each other by application of a corresponding multi-bit setting signal applied to setting terminals SET1 and SET2. More specifically, the first data driver 510 having the setting terminals SET1 and SET2 connected to the power voltage VDD1 and the ground voltage VSS, respectively, is first activated, and receives and stores the digital data provided by the timing controller 310. After the first data driver 510 finishes receiving the digital data, the second data driver 520 having the setting terminals SET1 and SET2 both connected to the ground voltage VSS is activated, and receives and stores the digital data provided by the timing controller 310. After the second data driver 520 finishes receiving the digital data, the third data driver 530 having the setting terminals SET1 and SET2 connected to the ground voltage VSS and power voltage VDD1, respectively, is activated, and receives and stores the digital data provided by the timing controller 310. After the third data driver 530 finishes receiving the digital data, the fourth data driver 540 having the setting terminals SET1 and SET2 both connected to the power voltage VDD1 is activated, and receives and stores the digital data provided by the timing controller 310. Finally, after the fourth data driver 540 finishes receiving the digital data, the fifth data driver 550 having the setting terminals SET1 and SET2 respectively connected to the power voltage VDD1 and the floating voltage is activated, and receives and stores the digital data provide by the timing controller 310.

The five data drivers 510 through 550 are thus sequentially activated to receive the digital data provided by the timing controller 310. Once the five data drivers 510 through 550 finish receiving the digital data, they respectively generate corresponding driving signals in accordance with the stored digital data and in response to the driving instruction signal provided by the timing controller 310. In this manner, the driving signals may be applied to the data lines DL11 through DL5n of the display panel 330.

As with the particulars of FIG. 4, the setting signal definitions of FIG. 5 are merely selected examples.

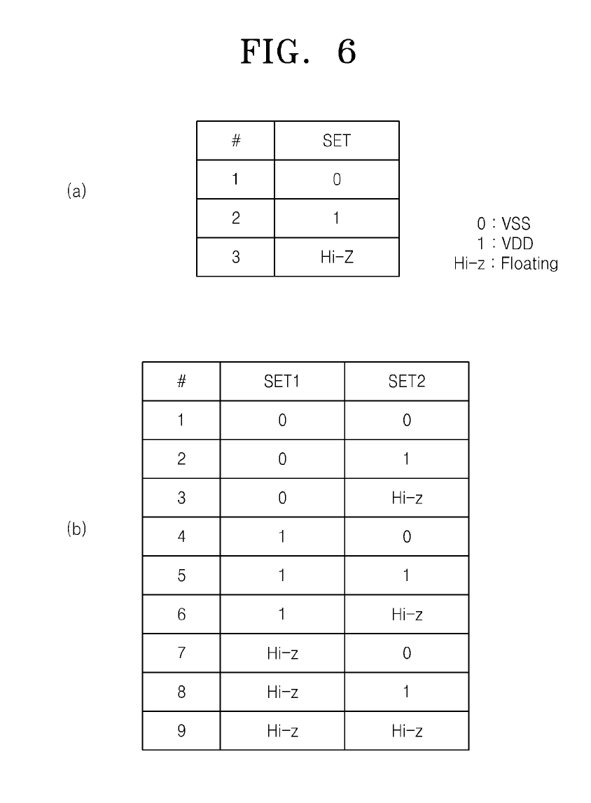

FIGS. 6A and 6B are tables listing some possible setting signal definitions for the data drivers of the data line driving unit 320 of FIG. 3. Referring to FIG. 6A, the table shows a combination of up to three data drivers identified by a single bit value setting signal SET. Referring to FIG. 6B, the table shows a combination of up to nine data drivers identified by a 2-bit setting signal SET1 and SET2. Each of bit values associated with these setting signals SET, SET1, and SET2 may be high, low, or Hi-Z.

For descriptive convenience of the illustrated embodiments that follow, a display apparatus consistent with the present inventive concept is assumed to transmit 8-bit pixel data between a timing controller and five data drivers via six (6) pairs of transmission lines using to a mini-low-voltage differential signaling (LVDS) standard interface. Each of the five data drivers is further assumed to include 720 output channels. However, as will be recognized by those skilled in the art the inventive concept is not limited to only these design particulars.

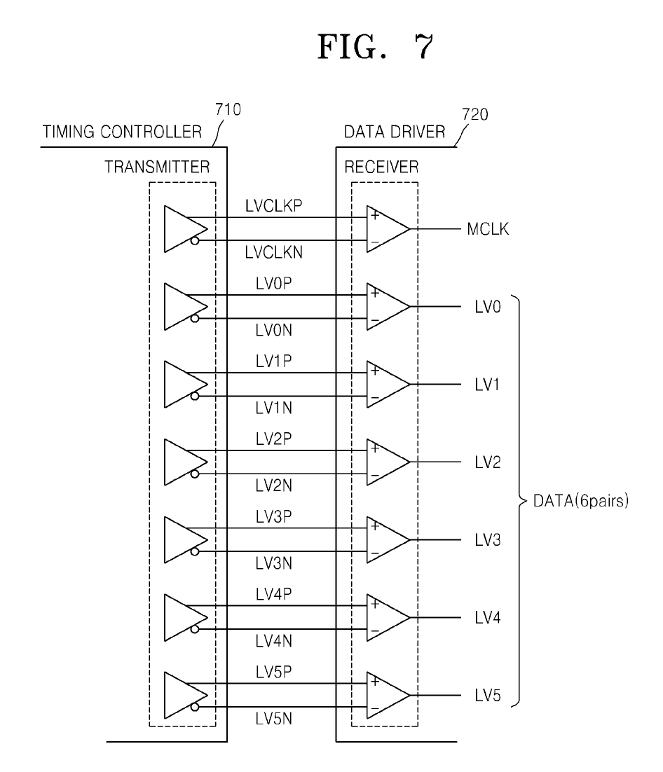

FIG. 7 is a diagram illustrating the use of a mini-LVDS interface between a timing controller 710 and a data driver 720 included within a display apparatus according to an embodiment of the inventive concept. Referring to FIG. 7, the timing controller 710 includes a clock transmitter that differentially transmits a master clock signal MCLK via a pair of clock lines LVCLKP and LVCLKN, and six data transmitters that differentially transmit 8-bit data through six pairs of data lines LV0P, LV0N, LV1P, LV1N, LV2P, LV2N, LV3P, LV3N, LV4P, LV4N, LV5P, and LV5N. Each transmitter converts a complementary metal oxide semiconductor (CMOS)/task transaction level (TTL) signal into a mini-LVDS signal and transmits the mini-LVDS signal. The data driver 720 includes a clock receiver that restores the master clock signal MCLK differentially transmitted through the clock lines LVCLKP and LVCLKN, and six data receivers that receive digital data transmitted through the data lines LV0P, LV0N, LV1P, LV1N, LV2P, LV2N, LV3P, LV3N, LV4P, LV4N, LV5P, and LV5N. Each receiver converts a mini-LVDS signal into a CMOS/TTL signal and transmits the CMOS/TTL signal.

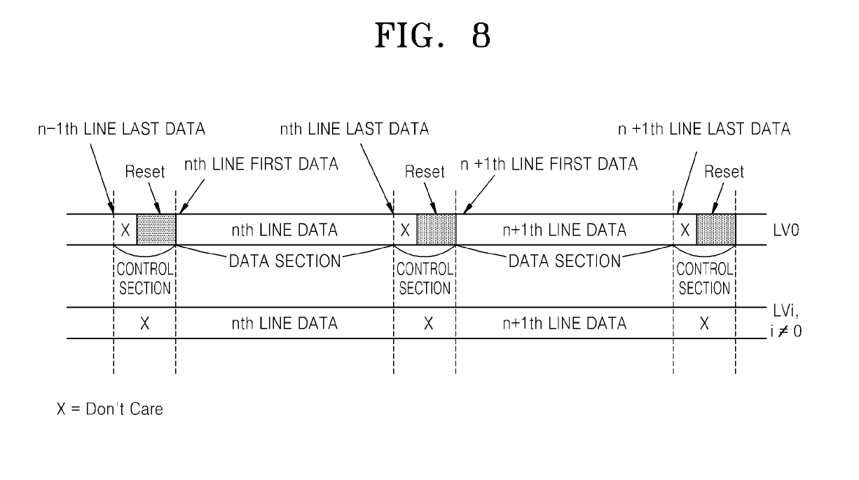

FIGS. 8 and 9 illustrate one possible protocol that may be used in conjunction with the mini-LVDS interface of FIG. 7. The data communication protocol for the Mini-LVDS interface may be used between a timing controller and data drivers divided into data sections and control sections. In the data sections, horizontal line data (hereinafter, line data) of a display panel is transmitted, and, in the control sections, a control signal for controlling the data drivers is transmitted.

Referring to FIG. 8, the timing controller transmits a reset pulse (Reset) in the control sections before outputting the line data. The reset pulse is transmitted in the control sections to the data drivers via a first pair of lines LV0 among six pairs of data transmission lines. The reset pulse is a signal indicating an output of the line data to the data drivers. The data drivers are initialized when receiving the reset pulse and are prepared to determine whether the data drivers reach respective activation times.

Referring to FIG. 9, once the timing controller finishes transmitting the line data in the control sections, the timing controller transmits a driving instruction signal (TP1). The driving instruction signal is transmitted to the data drivers via another transmission line, that is, a transmission line dedicated to the driving instruction signal. The driving instruction signal is a signal indicating complete transmission of the line data to the data drivers. Once the data drivers receive the driving instruction signal from the timing controller, they generate driving signals corresponding to the stored digital data and output the driving signals to the display panel.

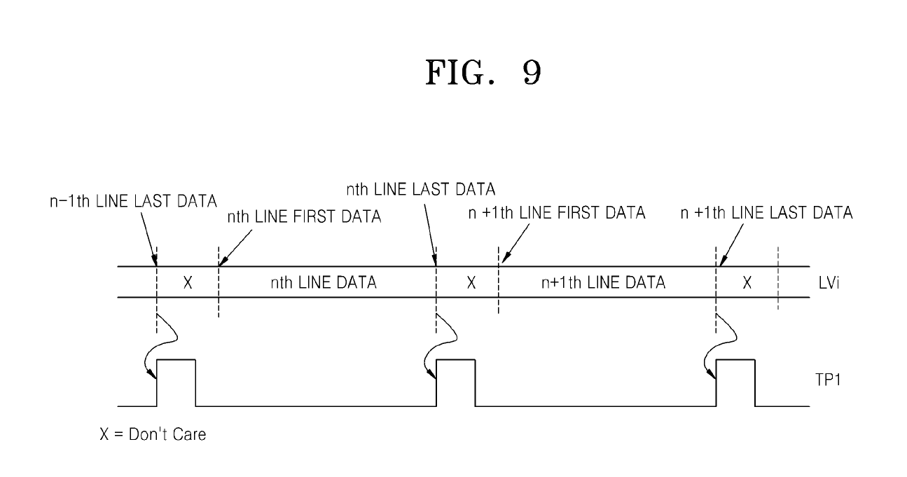

FIG. 10 is a data diagram illustrates data received by data drivers according to the mini-LVDS interface of FIG. 7. Referring to FIG. 10, eight bits included in 8-bit pixel data are transmitted in series to a pair of data lines LViP and LViN. Six pieces of 8-bit pixel data 1R, 1G, 1B, 2R, 2G, and 2B are transmitted in parallel through six pairs of data lines LV0P, LV0N, LV1P, LV1N, LV2P, LV2N, LV3P, LV3N, LV4P, LV4N, LV5P, and LV5N. The data drivers sample the six pieces of 8-bit pixel data 1R, 1G, 1B, 2R, 2G, and 2B at rising and falling edges Edge of the master clock signal MCLK. Thus, the data drivers receive two bits included in each of the six pieces of 8-bit pixel data 1R, 1G, 1B, 2R, 2G, and 2B during one cycle of the master clock signal MCLK and thus receive the six pieces of 8-bit pixel data during four cycles. The data drivers store the received six pieces of 8-bit pixel data 1R, 1G, 1B, 2R, 2G, and 2B, and accordingly an internal clock signal HCLK as a reference clock signal for storing data transmitted from a timing controller is obtained by dividing the frequency of the master clock signal MCLK by 4. Therefore, the data drivers receive and store the six pieces of 8-bit pixel data 1R, 1G, 1B, 2R, 2G, and 2B during four cycles of the master clock signal MCLK or a cycle of the internal clock signal HCLK.

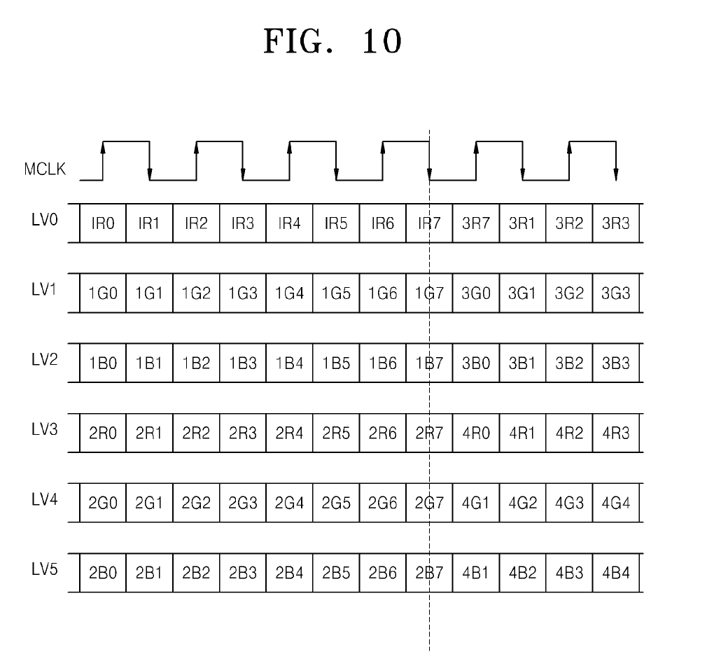

FIG. 11 is a diagram illustrating the output of n^{th} line data from a timing controller as distributed across five data drivers included in a display apparatus according to an embodiment of the inventive concept. Each of the five data drivers is assumed for purposes of illustration to includes 720 output channels and thus to receive 720-bit pixel data. Each of the five data drivers receives six blocks of pixel data during four cycles of the master clock signal (MCLK). Thus, (720/6)*4=480 cycles are needed for each of the five data drivers to completely receive the 720-bit pixel data from the timing controller.

More specifically, each of the five data drivers is initialized in response to a reset pulse and counts the master clock signal. The first data driver receives and stores the 720 pixel data during 480 cycles after receiving the reset pulse. The second data driver receives and stores the 720 pixel data during 480 cycles once 480 cycles has elapsed since receiving the reset pulse. The third data driver receives and stores the 720 pixel data during 480 cycles once 960 cycles has elapsed since receiving the reset pulse. The fourth data driver receives and stores the 720 pixel data during 480 cycles once 1440 cycles has elapsed since receiving the reset pulse, and the fifth data driver receives and stores the 720 pixel data during 480 cycles once the 1920 cycles has elapsed since receiving the reset pulse. In this manner, the five data drivers may be sequentially activated to receive the n^{th} line data output from the timing controller.

As described above, an activation sequence, (i.e., the collection of activation times) for the five data drivers may be set as required to ensure desired operation. However, the five data drivers may generally be provided with a similar structure. Thus, information regarding a pre-set activation time for specific (differently structured) data drivers needs to be tracked and accounted for during design, manufacture and operation. To this end, each of the five data drivers receives distinct setting signals SET1 and SET2 and functions according to an activation time thereby defined. In essence, the setting signals SET1 and SET2 are used to determine an activation clock (or an activation signal) for each of the five data drivers all flowing from a common reference point in time (or a common reference activation). The activation times of the five data drivers included in the display apparatus may be determined according to the activation sequence of the five data drivers. The design specification of the display apparatus may include the bit number of each piece of pixel data, a data interfacing method between a timing controller and data drivers, the number of data drivers, and the number of output channels of each data driver. For example, as mentioned above, for descriptive convenience, the design specification of the display apparatus is to communicate 8-bit pixel data between the timing controller and the five data drivers through 6 pairs of transmission lines according to a mini-LVDS standard interface. Each of the five data drivers includes 720 output channels. Thus, a first activated data driver is activated after the reference point, a second activated data driver is activated once 480 cycles have elapsed since the reference point, a third activated data driver is activated once 960 cycles have elapsed since the reference point, a fourth activated data driver is activated once 1440 cycles have elapsed since the reference point, and a fifth and final activated data driver is activated once 1920 cycles have elapsed since the reference point. In this manner, the setting signals SET1 and SET2 applied to each of the five data drivers may be used to set the activation sequence of the five data drivers. In other words, any one of a plurality of values determined according to the design specification of the display apparatus by using the setting signals SET1 and SET2 is selected as the activation times of the five data drivers.

Each of the five data drivers counts the master clock signal after the reference point in order to determine whether each of the five data drivers has reached the activation time thereof determined according to the setting signals SET1 and SET2. If a counting result is that one of the five data drivers reaches a threshold determined according to the setting signals SET1 and SET2, the data driver is activated, receives data from the timing controller, and stores the data therein. The reference point may be a point in which the reset pulse is received. In this case, the reset pulse leads to synchronization of a clock counting operation of the five data drivers, and thus the counting result is initialized.

Meanwhile, the five data drivers may count an internal clock signal (HCLK) instead of the master clock signal (MCLK) in order to determine whether each of the five data drivers has reached the activation time thereof.

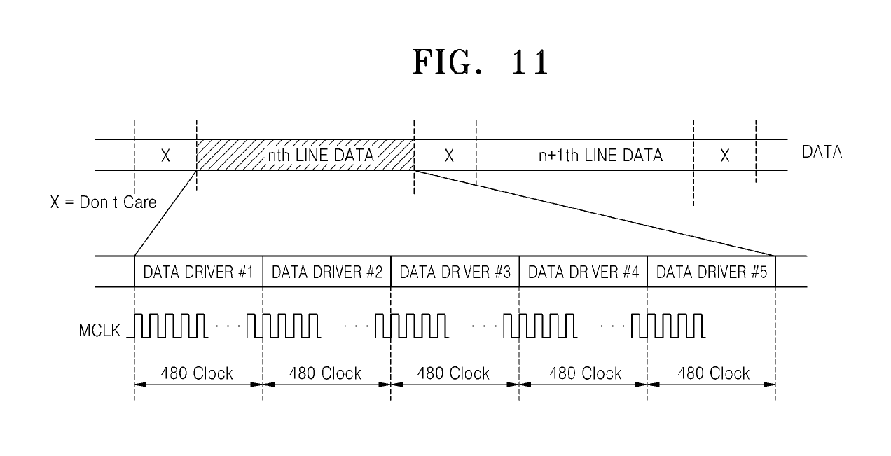

FIG. 12 is a block diagram of a data driver 1200 according to an embodiment of the inventive concept. Referring to FIG. 12, the data driver 1200 generally comprises a data processing unit 1210 and a driving signal output unit 1220.

The data processing unit 1210 receives externally provided master clock signal (MCLK), digital data (DATA), driving instruction signal (TP1), and setting signals (SET1 and SET2), and transmits n blocks of 8-bit pixel data to n output channels to the driving signal output unit 1220. More specifically, the data processing unit 1210 is activated at a time determined by the setting signals SET1 and SET2. The activated data processing unit 1210 receives and stores the digital data synchronously with the master clock signal. Once the data processing unit 1210 finishes receiving the necessary digital data, it is deactivated and no longer stores externally provided data. In this regard, the activation of the data processing unit 1210 includes activation of circuitry receiving and storing the data within the data processing unit 1210. Thus, operation of the data processing unit 1210 to output the stored digital data is not limited by whether the data processing unit 1201 is activated or deactivated. The data processing unit 1201 transmits the stored digital data to the driving signal output unit 1220 in response to the driving instruction signal.

The driving signal output unit 1220 comprises a level converting unit 1222, a digital-analog converting unit 1224, and an output buffer unit 1226. The level converting unit 1222 converts a voltage level of the digital data output from the data processing unit 1210 to a level suitable for driving a display panel (not shown). The digital-analog converting unit 1224 converts the digital data having the level converted by the level converting unit 1222 into an analog signal. The output buffer unit 1226 buffers the analog signal converted by the digital-analog converting unit 1224 and outputs the buffered analog signal to data lines DL1 through DLn of the display panel (not shown).

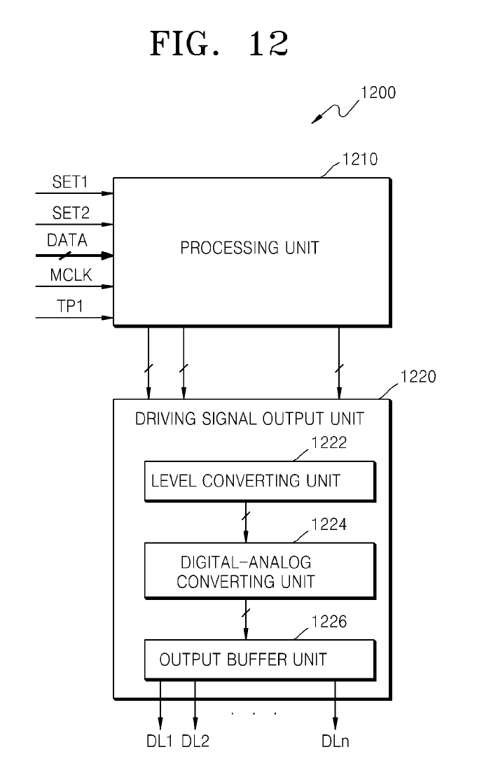

FIG. 13 is a block diagram further illustrating the data processing unit 1210 of FIG. 12. Referring to FIG. 13, the data processing unit 1210 comprises a receiving unit 1212, a control unit 1214, and a data storage unit 1216. The receiving unit 1212 receives the master clock signal, digital data, and driving instruction signal from a timing controller (not shown), and outputs an internal clock signal (HCLK), a reset signal (RST), the digital data (DATA), and the driving instruction signal (TP1). More specifically, the receiving unit 1212 restores the master clock signal having a mini-LVDS signal level output from the timing controller (not shown) through a pair of clock transmission lines to the master clock signal having a CMOS/TTL signal level, divides the frequency of the master clock signal by (e.g.,) 4 to generate the internal clock signal. Further, the receiving unit 1212 restores the digital data having the mini-LVDS signal level output from the timing controller (not shown) through six pairs of clock transmission lines to the digital data having the CMOS/TTL signal level, samples the digital data synchronously with the master clock signal, and reconfigures the sampled digital data into six blocks of 8-bit pixel data.

The control unit 1214 receives and counts the internal clock signal from the receiving unit 1212, and, at a time determined by externally applied setting signals SET1 and SET2, generates and outputs an enable pulse (EN). More specifically, the control unit 1214 is initialized by the reset signal to count the internal clock signal. A threshold is determined according to a logic combination of the setting signals SET1 and SET2. If the control unit 1214 counts the internal clock signal up to the threshold, the control unit 1214 generates and outputs the enable pulse.

The data storage unit 1216 includes a shift register unit 1216_2, a first latch unit 1216_4, and a second latch unit 1216_6. The shift register unit 1216_2 controls the first latch unit 1216_4 in response to the enable pulses provided by the control unit 1214. The shift register unit 1216_2 sequentially shifts and outputs the received enable pulses EN in synchronization with the internal clock signal.

The first latch unit 1216_4 stores the digital data provided by the receiving unit 1212 in response to the enable pulses that are shifted and output by the shift register unit 1216_2.

Once the first latch unit 1216_4 finishes storing the digital data, the first latch unit 1216_4 simultaneously stores the digital data in the second latch unit 1216_6 in response to the driving instruction signal.

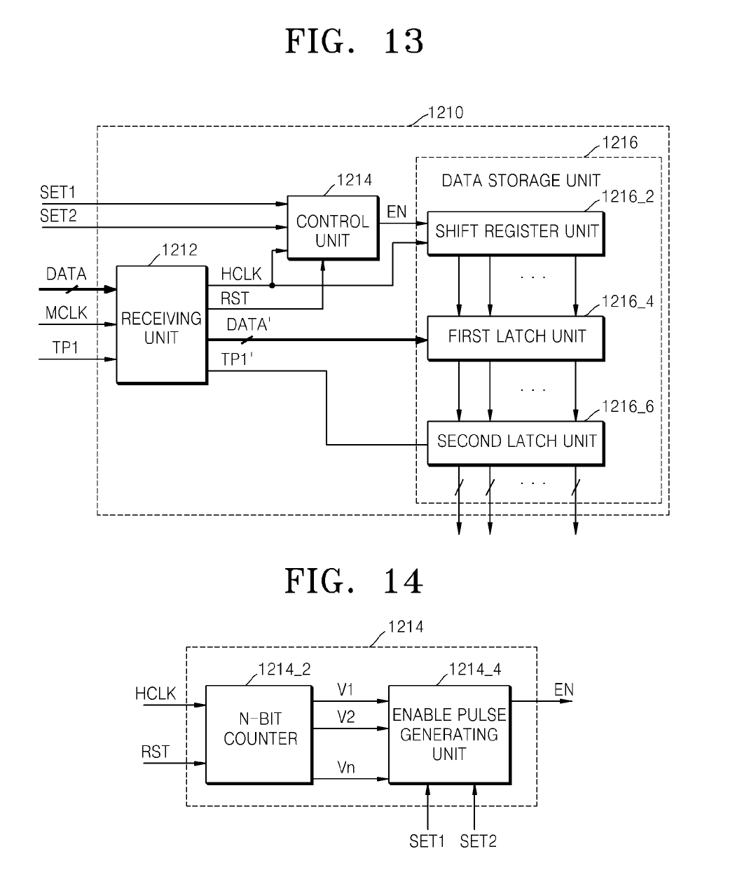

FIG. 14 is a block diagram further illustrating the control unit 1214 of FIG. 13. Referring to FIG. 14, the control unit 1214 includes an N-bit counter 1214_2 and an enable pulse generating unit 1214_4. The N-bit counter 1214_2 is initialized in response to the reset pulse to count the internal clock signal. The enable pulse generating unit 1214_4 receives the setting signals SET1 and SET2, and once an output of the counter 1214_2 is the same as a threshold determined by the setting signals SET1 and SET2, generates and outputs the enable pulse. The enable pulse generating unit 1214_4 may generate and output the enable pulse according to a logic combination of the received setting signals SET1 and SET2 and the output of the N-bit counter 1214_2.

While the inventive concept has been particularly shown and described with reference to exemplary embodiments thereof, it will be understood that various changes in form and details may be made therein without departing from the scope of the following claims.

What is claimed is:

1. A display apparatus comprising:
a display panel;
a timing controller that provides a master clock signal and digital data; and
a data line driving unit comprising a plurality of data drivers, each configured to receive the master clock signal, receive and store the digital data, generate driving signals in accordance with the stored digital data, and provide corresponding driving signals to the display panel,
wherein the plurality of data drivers is sequentially activated to receive and store the digital data in response to a corresponding one of a plurality of setting signals.

2. The display apparatus of claim 1, wherein each one of the plurality of setting signals has a different multi-bit value.

3. The display apparatus of claim 1, wherein each of the plurality of data drivers comprises a counter that counts an internal clock signal and each one of the plurality of data drivers is activated when an output of the counter equals a threshold value.

4. The display apparatus of claim 3, wherein the internal clock signal is derived from the master clock signal.

5. The display apparatus of claim 4, wherein the threshold value is determined in accordance with the corresponding one of the plurality of setting signals.

6. The display apparatus of claim 5, wherein the counter is initialized by a reset signal corresponding to a horizontal line for the display panel.

7. A display apparatus comprising:
a display panel;
a timing controller that provides a master clock signal, digital data, and a driving instruction signal; and
a data line driving unit comprising a plurality of data drivers, each configured to receive the master clock signal, receive and store the digital data, generate driving signals in accordance with the stored digital data, and provide corresponding driving signals to the display panel,
wherein the plurality of data drivers is sequentially activated to receive and store the digital data in response a corresponding one of a plurality of setting signals, and
each of the plurality of data drivers comprises:
a data processing unit that receives the digital data synchronously with the master clock signal and stores the received digital data; and
a driving signal output unit that generates the driving signals in response to the stored digital data and the driving instruction signal, and provides the driving signals to the display panel.

8. The display apparatus of claim 1, wherein each one of the plurality of setting signals is defined by at least one of a first voltage indicating a logical high, a second voltage indicating a logical low, and a voltage indicating a high impedance state.

9. The display apparatus of claim 8, wherein the data processing unit comprises:
a receiving unit that receives the master clock signal, derives an internal clock signal from the master clock signal, and receives the digital data synchronously with the master clock signal;
a data storage unit that sequentially stores the digital data received in response to enable pulses and provides the digital data to the driving signal generating unit in response to the driving instruction signal; and
a control unit that generates the enable pulses in response to the corresponding one of the plurality of setting signals.

10. The display apparatus of claim 9, wherein the data storage unit comprises:
a shift register that sequentially shifts and outputs the enable pulses in response to the internal clock signal;
a first latch unit that sequentially stores the digital data in response to the enable pulses; and
a second latching unit that stores the digital data to the first latch unit in response to the driving instruction signal and outputs the digital data to the driving signal generating unit.

11. The display apparatus of claim 10, wherein the control unit comprises:
a counter that counts the internal clock signal and provides a counted value; and
a pulse generating unit that generates the enable pulses once the counted value equals a threshold value,
wherein the threshold value is determined by the corresponding one of the plurality of setting signals.

12. The display apparatus of claim 11, wherein the counter is initialized by a reset signal corresponding to a horizontal line for the display panel.

13. The display apparatus of claim 12, wherein the counter is an N-bit counter and the pulse generating unit generates the enable pulses using a logic combination of at least one of N bits provided by the counter.

14. A data driver driving a display panel, the data driver comprising:
a data processing unit that receives digital data synchronously with a master clock signal and stores the received digital data; and
a driving signal output unit that generates driving signals in response to the stored digital data and a driving instruction signal, and provides the driving signals to a display panel,
wherein the data processing unit is activated at a time determined by an applied setting signal.

15. The data driver of claim 14, wherein the setting signal is defined by at least one of a first voltage indicating a logical high, a second voltage indicating a logical low, and a voltage indicating a high impedance state.

16. The data driver of claim 15, wherein the data processing unit comprises:
a receiving unit that receives the master clock signal, derives an internal clock signal from the master clock signal, and receives the digital data synchronously with the master clock signal;
a data storage unit that sequentially stores the digital data received in response to enable pulses, and outputs the digital data to the driving signal generating unit in response to the driving instruction signal; and
a control unit that generates the enable pulses in response to the setting signal.

17. The data driver of claim 16, wherein the data storage unit comprises:
a shift register that sequentially shifts and outputs the enable pulses in response to the internal clock signal;
a first latch unit that sequentially stores the digital data in response to the enable pulses; and
a second latching unit that stores the digital data to the first latch unit in response to the driving instruction signal and outputs the digital data to the driving signal generating unit.

18. The data driver of claim 17, wherein the control unit comprises:
a counter that counts the internal clock signal and provides a counted value; and
a pulse generating unit that generates the enable pulses once the counted value equals a threshold value,
wherein the threshold value is determined by the corresponding one of the plurality of setting signals.

19. The display driver of claim 18, wherein the counter is initialized by a reset signal corresponding to a horizontal line for the display panel.

20. The display driver of claim 19, wherein the counter is an N-bit counter and the pulse generating unit generates the enable pulses using a logic combination of at least one of N bits provided by the counter.
